(19) United States
(12) Patent Application Publication
(10) Pub. No.: US 2025/0010527 A1
(43) Pub. Date: Jan. 9, 2025

(54) HIGH-STRENGTH MOLDED BODY AND METHOD FOR MANUFACTURING SAME

(71) Applicant: Kyoto University, Kyoto (JP)

(72) Inventors: Hiroyuki YANO, Kyoto (JP); Takashi KUBOKI, Kyoto (JP); Hironari SANO, Kyoto (JP); Arimitsu USUKI, Kyoto (JP); Hiroshi ITO, Yamagata (JP); Shotaro NISHITSUJI, Yamagata (JP); Takashi INOUE, Yamagata (JP); Yukino ITO, Yamagata (JP)

(73) Assignee: Kyoto University, Kyoto (JP)

(21) Appl. No.: 18/710,026

(22) PCT Filed: Jan. 17, 2022
(86) PCT No.: PCT/JP2022/001458

§ 371 Date: May 14, 2024

(30) Foreign Application Priority Data
Nov. 17, 2021 (JP) 2021-186857

(51) Int. Cl. B29C 45/00; B29K 1/00; B29K 101/12; B29L 31/40

(52) U.S. Cl. CPC B29C 45/0001; B29C 45/0055; B29K 2001/00; B29K 2101/12; B29K 2995/0077; B29K 2995/0097; B29L 2031/40

(57) ABSTRACT

A molded article with improved mechanical strength properties and thermal properties, and a method for producing the molded article. A composite molded article (C) comprising a cellulosic nanomaterial (A) and a thermoplastic resin (B), an area under a stress-strain curve of the composite molded article (C) (AUC1) being at least two times an area under a stress-strain curve of a melt-molded article (D) having the same composition as that of the composite molded article (C) (AUC2), wherein the stress-strain curve is a curve drawn with strain (unit: %) on the horizontal axis and stress (unit: MPa) on the vertical axis and obtained by subjecting the composite molded article (C) or the melt-molded article (D) to a tensile test, and the area is an area up to the horizontal axis from under a curved portion of the curve that is from the origin (stress: 0) of the stress-strain curve to a fracture of the composite molded article (C) or the melt-molded article (D).

### TECHNICAL FIELD

The present invention relates to a composite molded article with excellent strength properties that comprises a cellulosic nanomaterial (A) and a thermoplastic resin (B), and a method for producing the composite molded article.

### BACKGROUND ART

Fiber-reinforced plastics, which are lightweight and excellent in mechanical strength, are used in, for example, automobile exterior panels and interior materials, housings for electrical equipment, and building materials to reduce greenhouse gas emissions, and are expected to be a means for creating a decarbonized society.

With regard to plant-derived fiber-reinforced plastics, Patent Literature (PTL) 1 discloses a resin composition comprising microfibrillated plant fibers chemically modified with an alkyl or alkenyl succinic anhydride, a method for producing the resin composition, and a molded article.

PTL 2 discloses various chemically modified nanocellulose fibers in which functional groups with high functionality are introduced into the surface of nanocellulose, and a resin composition comprising such chemically modified nanocellulose fibers.

PTL 3 discloses a fiber-reinforced resin composition comprising lignocellulose nanofibers with specific physical properties chemically modified with an acyl group or the like, and a thermoplastic resin; and a molded article of the composition.

PTL 4 discloses a method for producing a thermoplastic resin composition, comprising kneading a thermoplastic resin and plant fibers such as kenaf to produce a resin fiber mixture (containing 50 to 95 mass % plant fibers) and rolling the resin fiber mixture to form a plate-shaped rolled article.

PTL 5 discloses a resin composition with improved tensile elongation that comprises cellulose nanofibers, a specific organic component, an acid-modified polyolefin, and a polyolefin-based resin.

PTL 6 discloses a high-strength hard-soft laminate structural material composed of a polymer.

### CITATION LIST

### Patent Literature

PTL 1: JP2012-214563A
PTL 2: JP2014-148629A
PTL 3: JP2017-025338A
PTL 4: JP2011-005742A
PTL 5: JP2019-131774A
PTL 6: JP2019-202532A

### SUMMARY OF INVENTION

### Technical Problem

Conventional composite molded articles (e.g., injection-molded articles) made of fiber-reinforced resin compositions possess improved strength and elastic modulus because fibers are combined; however, they have low elongation and are brittle. An object of the present invention is to provide a molded article with improved mechanical strength properties and thermal properties that comprises a cellulosic nanomaterial and a thermoplastic resin, and a method for producing the molded article.

### Solution to Problem

The present inventors conducted extensive research to achieve the above object, and found that a composite molded article (C) comprising a cellulosic nanomaterial (A) and a thermoplastic resin (B) prepared by a specific molding method has excellent mechanical properties such as strength, elastic modulus, and elongation, and excellent thermal properties (low coefficient of thermal expansion). The present invention has been accomplished based on this finding.

The present invention encompasses, for example, the molded articles and production methods therefor described in the following items.

### Item 1.

A composite molded article (C) comprising a cellulosic nanomaterial (A) and a thermoplastic resin (B), an area under a stress-strain curve of the composite molded article (C) (AUC1) being at least two times an area under a stress-strain curve of a melt-molded article (D) having the same composition as that of the composite molded article (C) (AUC2),
wherein the stress-strain curve is a curve drawn with strain (unit: %) on the horizontal axis and stress (unit: MPa) on the vertical axis and obtained by subjecting the composite molded article (C) or the melt-molded article (D) to a tensile test, and the area is an area up to the horizontal axis from under a curved portion of the curve that is from the origin (stress: 0) of the stress-strain curve to a fracture of the composite molded article (C) or the melt-molded article (D).

### Item 2.

The composite molded article (C) according to Item 1, wherein the composite molded article (C) is at least one molded article selected from the group consisting of warm-sheared molded articles, warm-compressed molded articles, warm-stretched molded articles, and warm-rolled molded articles, of the melt-molded article (D).

### Item 3.

The composite molded article (C) according to Item 1 or 2, wherein the composite molded article (C) has a tensile elastic modulus (E4c) that is at least 1.05 times a tensile elastic modulus of the melt-molded article (D) having the same composition as that of the composite molded article (C) (EMd).

### Item 4.

The composite molded article (C) according to Item 1 or 2, wherein the composite molded article (C) has at least one of the following features (1) to (4):
(1) the composite molded article (C) has a tensile elastic modulus (EMc) that is at least 1.05 times a tensile elastic modulus of the melt-molded article (D) having the same composition as that of the composite molded article (C) (EMd),
(2) the composite molded article (C) has a tensile strength that is at least 1.2 times a tensile strength of the melt-molded article (D) having the same composition as that of the composite molded article (C),
(3) the composite molded article (C) has a breaking strain that is at least two times a breaking strain of the melt-molded article (D) having the same composition as that of the composite molded article (C), and
(4) the composite molded article (C) has a coefficient of linear thermal expansion (CTE) at 40° C. to 80° C. of −5 to 147 (ppm/K).

### Item 5.

The composite molded article (C) according to any one of Items 1 to 4, wherein the cellulosic nanomaterial (A) is at least one cellulosic nanomaterial selected from the group consisting of microfibrillated cellulosic fibers, fine cellulosic powders, and cellulose nanocrystals, all of which are optionally chemically modified.

### Item 6.

The composite molded article (C) according to Item 5, wherein the cellulosic nanomaterial (A) is at least one cellulosic nanomaterial in which some of the hydroxyl groups of sugar chains and/or lignin constituting the material are modified with at least one chemical bond selected from the group consisting of the following (i) to (iii), the at least one cellulosic nanomaterial being selected from the group consisting of microfibrillated cellulosic fibers, fine cellulosic powders, and cellulose nanocrystals:
(i) an ester bond with a carboxylic acid represented by the following formula (1):

R—COOH (1)
wherein R represents (a) an alkyl or alkenyl group, (b) an optionally crosslinked or fused alicyclic hydrocarbon group, (c) an oxyalkyl group substituted with an optionally crosslinked or fused alicyclic hydrocarbon group, or (d) a phenoxyalkyl group, an alkyl-substituted phenoxyalkyl group, or a phenoxyalkyl group substituted with an optionally crosslinked or fused alicyclic hydrocarbon group,
(ii) a half ester bond with an alkyl or alkenyl succinic anhydride, and
(iii) an ether bond with a carboxymethyl group, a carboxyethyl group, a hydroxyethyl group, a 2-hydroxypropyl group, or a cyanoethyl group.

### Item 7.

The composite molded article (C) according to any one of Items 1 to 6, wherein the cellulosic nanomaterial (A) has a minor axis of 1 nm to 10 μm.

### Item 8.

The composite molded article (C) according to any one of Items 1 to 7, wherein the thermoplastic resin (B) is at least one resin selected from the group consisting of polyolefins, polyamides, aliphatic polyesters, aromatic polyesters, polyacetals, polycarbonates, polystyrene, (meth)acrylic resins, acrylonitrile-butadiene-styrene copolymers (ABS resins), polycarbonate-ABS alloys (PC-ABS alloys), modified polyphenylene ethers (m-PPE), vinyl chloride resins, cellulosic resins, polylactic acid (PLA), polyhydroxybutyrate (PHBT), polyhydroxyhexanoate (PHAT), copolymers of polyhydroxybutyrate and polyhydroxyhexanoate (PHBH), and polybutylene succinate (PBS).

### Item 9.

The composite molded article (C) according to any one of Items 1 to 8, further comprising a compatibilizer and/or an inorganic filler.

### Item 10.

The composite molded article (C) according to any one of Items 1 to 9, wherein the content of the cellulosic nanomaterial (A) is 1 to 70 mass % based on the mass of the composite molded article (C).

### Item 11.

A method for producing a composite molded article (C) comprising a cellulosic nanomaterial (A) and a thermoplastic resin (B), the method comprising:
(1) melting a composition comprising the cellulosic nanomaterial (A) and the thermoplastic resin (B) to prepare a molten composite composition comprising the cellulosic nanomaterial (A) and the thermoplastic resin (B) (step 1);
(2) molding the molten composite composition obtained in step 1 in a molten state, followed by cooling, thereby preparing a melt-molded article (D) (step 2); and
(3) warm-forming the melt-molded article (D) obtained in step 2 by at least one method selected from the group consisting of shearing, compression, stretching, and rolling (step 3),
an area under a stress-strain curve of the composite molded article (C) (AUC1) being at least two times an area under a stress-strain curve of the melt-molded article (D) (AUC2),
wherein the stress-strain curve is a curve drawn with strain (unit: C) on the horizontal axis and stress (unit: MPa) on the vertical axis and obtained by subjecting the composite molded article (C) or the melt-molded article (D) to a tensile test, and the area is an area up to the horizontal axis from under a curved portion of the curve that is from the origin (stress: 0) of the stress-strain curve to a fracture of the composite molded article (C) or the melt-molded article (D).

### Item 12.

The method for producing a composite molded article (C) according to Item 11, wherein when the thermoplastic resin (B) is a crystalline resin, the temperature in the warm-forming is less than the melting point of the crystalline resin, when the thermoplastic resin (B) is an amorphous resin, the temperature in the warm-forming is less than the glass transition temperature of the amorphous resin, and when the thermoplastic resin (B) is a mixture of a crystalline resin and an amorphous resin, the temperature in the warm-forming is less than the melting point of the crystalline resin.

### Item 13.

The method for producing a composite molded article (C) according to Item 11 or 12, wherein in the warm-forming, the ratio of the thickness of the composite molded article (C) (Ct) to the thickness of the melt-molded article (D) (Dt) (Ct/Dt) is 0.1 to 0.9.

### Item 14.

A method for producing a composite molded article (C) comprising a cellulosic nanomaterial (A) and a thermoplastic resin (B), the method comprising:
(1) melting a composition comprising the cellulosic nanomaterial (A) and the thermoplastic resin (B) to prepare a molten composite composition comprising the cellulosic nanomaterial (A) and the thermoplastic resin (B) (step 1);
(2) injection-molding the molten composite composition obtained in step 1 to prepare an injection-molded article (E) (step 2); and
(3) warm-forming the injection-molded article (E) obtained in step 2 by at least one method selected from the group consisting of shearing, compression, stretching, and rolling (step 3),
an area under a stress-strain curve of the composite molded article (C) (AUC1) being at least two times an area under a stress-strain curve of the melt-molded article (D) (AUC2),
wherein the stress-strain curve is a curve drawn with strain (unit: %) on the horizontal axis and stress (unit: MPa) on the vertical axis and obtained by subjecting the composite molded article (C) or the melt-molded article (D) to a tensile test, and the area is an area up to the horizontal axis from under a curved portion of the curve that is from the origin (stress: 0) of the stress-strain curve to a fracture of the composite molded article (C) or the melt-molded article (D).

### Advantageous Effects of Invention

The molded article of the present invention has excellent strength and elastic modulus, as well as improved elongation. That is, the composite molded article of the present invention is hard, strong, and tenacious. Further, since the molded article of the present invention contains a well-dispersed cellulosic nanomaterial, the molded article has a low coefficient of thermal expansion and excellent dimensional stability.

Thus, the composite molded article of the present invention can be suitably used in a small amount for production goods and consumer goods, such as automobile exterior panels and interior materials, housings for electrical equipment, and building materials, and enables weight reduction and reduction of environmental burden of such goods.

Furthermore, the composite molded article of the present invention is suitable for mass production with low energy. Thus, the composite molded article of the present invention can be produced with lower energy consumption, i.e., at lower cost than conventional composite molded articles.

Accordingly, the composite molded article of the present invention is useful in reducing life cycle CO₂ (LCCO₂) throughout its production, transportation, use, and recycling stages.

### BRIEF DESCRIPTION OF DRAWINGS

FIG. 1 show schematic diagrams illustrating rolled samples (substantially elliptical) and the positions of dumbbell-shaped test pieces cut out from the samples.

FIG. 2 shows stress-strain curves of the test pieces obtained in Examples 5 and 10 and Comparative Example 2. Hatched portions under the stress-strain curves of the test pieces of the Examples indicate the areas under the stress-strain curves of them (AUC1), and a hatched portion under the stress-strain curve of the test piece of the Comparative Example indicates the area under the stress-strain curve of it (AUC2).

### DESCRIPTION OF EMBODIMENTS

### 1. Explanation of Terms

The cellulosic nanomaterial (A) means that either the major axis or the minor axis of a cellulosic material is nm size or μm size (e.g., 1 nm to 999 μm), unless otherwise specified. When the cellulosic nanomaterial (A) has a complex shape including a projection portion, a protrusion portion, or an extension portion in addition to its main shape portion, it means that either the major axis or the minor axis of any one of the main shape portion, projection portion, protrusion portion, and extension portion is nm size or μm size, unless otherwise specified.

The cellulosic material means a material containing cellulose and optionally containing at least one member selected from the group consisting of lignin and hemicellulose, unless otherwise specified.

### 2. Features of Composite Molded Article

The composite molded article (C) of the present invention comprises a cellulosic nanomaterial (A) and a thermoplastic resin (B), and the area under the stress-strain curve of the composite molded article (C) (AUC1) is at least two times the area under the stress-strain curve of a melt-molded article (D) having the same composition as that of the composite molded article (C) (AUC2).

The area under the stress-strain curve of the composite molded article (C) (AUC1) is preferably at least four times the area under the stress-strain curve of the melt-molded article (D) having the same composition as that of the composite molded article (C) (AUC2). The area under the stress-strain curve of the composite molded article (C) (AUC1) may be, for example, 2 to 80 times or 4 to 80 times the area under the stress-strain curve of the melt-molded article (D) having the same composition as that of the composite molded article (C) (AUC2).

The stress-strain curve is a curve drawn with strain (unit: C) on the horizontal axis and stress (unit: MPa) on the vertical axis and obtained by subjecting the composite molded article (C) or the melt-molded article (D) to a tensile test.

The area under the stress-strain curve (AUC1 or AUC2) is an area up to the horizontal axis from under a curved portion of the stress-strain curve that is from the origin (stress: 0) of the stress-strain curve to a fracture of the composite molded article (C) or the melt-molded article (D). More specifically, the area under the stress-strain curve (AUC1 or AUC2) is an area of a region surrounded by a curved portion of the stress-strain curve from the origin (stress: 0) of the stress-strain curve to a fracture (fracture point) of the composite molded article (C) or the melt-molded article (D), a straight line connecting the fracture point on the curve and a point corresponding to the fracture point on the horizontal axis, and the horizontal axis.

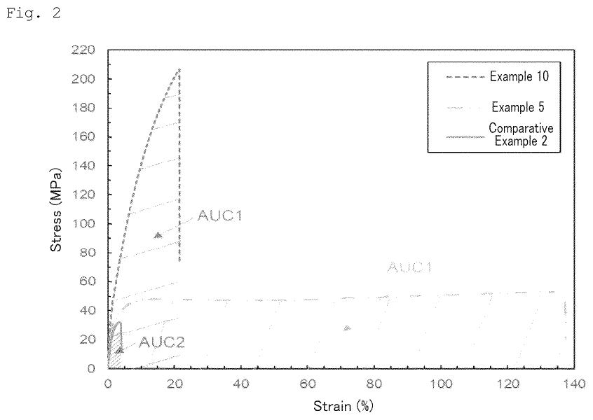

FIG. 2 shows the stress-strain curves of Examples (Examples 5 and 10) and Comparative Example (Comparative Example 2). The hatched portions under the stress-strain curves of the Examples (AUC1) shown in FIG. 2 each correspond to the area under the stress-strain curve of the composite molded article (C) of the present invention (AUC1), and the hatched portion under the stress-strain curve of the Comparative Example (AUC2) corresponds to the area under a stress-strain curve of the melt-molded article (D) (AUC2).

The area under the stress-strain curve can generally be determined by dividing the area between the curve and the strain axis into many trapezoids and summing their areas using software included with a tensile tester or Microsoft Excel software.

The melt-molded article (D) is a molded article obtained by melting a composition comprising a cellulosic nanomaterial (A) and a thermoplastic resin (B) to prepare a molten composite composition comprising the cellulosic nanomaterial (A) and the thermoplastic resin (B) and molding the molten composite composition in a molten state, followed by cooling. The melt-molded article (D) is a material for producing the composite molded article (C), as described later. When the composite molded article (C) is produced from the melt-molded article (D), the melt-molded article (D) and the composite molded article (C) have the same composition.

The composite molded article (C) may be produced by, for example, shearing, compressing, stretching, or rolling the melt-molded article (D), and these processing methods may be used singly or in a combination of two or more. Compression here encompasses compressing the melt-molded article (D) after injection. Preferred processing methods are rolling, shearing, and compression.

The composite molded article (C) may be at least one molded article selected from the group consisting of warm-sheared molded articles, warm-compressed molded articles, warm-stretched molded articles, and warm-rolled molded articles, of the melt-molded article (D). The warm-compressed molded article of the melt-molded article (D) encompasses a molded article obtained by compression molding after injection molding of the melt-molded article (D). The composite molded article (C) is preferably a warm-rolled molded article.

In warm-processing, when the thermoplastic resin (B) is a crystalline resin, the temperature in the forming may be less than the melting point of the crystalline resin; when the thermoplastic resin (B) is an amorphous resin, the temperature in the forming may be less than the glass transition temperature of the amorphous resin; and when the thermoplastic resin (B) is a mixture of a crystalline resin and an amorphous resin, the temperature in the forming may be less than the melting point of the crystalline resin. The lower limit of the temperature is room temperature (e.g., 10° C., 15° C., 20° C., 25° C., 30° C., 40° C., or 10 to 40° C.).

The composite molded article (C) has excellent tensile elasticity. The tensile elastic modulus of the composite molded article (C) (EMc) may be at least 1.05 times, preferably at least 1.3 times, and more preferably at least 1.4 times the tensile elastic modulus of the melt-molded article (D) having the same composition as that of the composite molded article (C) (EMd). The tensile elastic modulus of the composite molded article (C) (EMc) may be, for example, 1.05 to 3 times, 1.1 to 3 times, or 1.2 to 3 times the tensile elastic modulus of the melt-molded article (D) having the same composition (EMd).

The composite molded article (C) has high tensile strength. The tensile strength of the composite molded article (C) is preferably at least 1.2 times, more preferably at least 1.5 times, and even more preferably at least 1.6 times the tensile strength of the melt-molded article (D) having the same composition as that of the composite molded article (C). The tensile strength of the composite molded article (C) may be, for example, 1.2 to 8 times, 1.5 to 8 times, or 1.6 to 8 times the tensile strength of the melt-molded article (D) having the same composition.

The composite molded article (C) has a high breaking strain. The breaking strain of the composite molded article (C) is preferably at least three times, and more preferably at least five times the breaking strain of the melt-molded article (D) having the same composition as that of the composite molded article (C). The breaking strain of the composite molded article (C) may be 3 to 50 times or 5 to 50 times the breaking strain of the melt-molded article (D) having the same composition. The breaking strain is the magnitude of strain at which the test piece breaks in a tensile test.

The composite molded article (C) has low thermal expansion, and small dimensional fluctuations at high temperatures. The coefficient of linear thermal expansion (CTE) of the composite molded article (C) may be within a small numerical range. The CTE at 40° C. to 80° C. is preferably within the numerical range of −5 to 147 (ppm/K), and more preferably within the numerical range of 16 to 127 (ppm/K). Further, the composite molded article (C) contracts when the temperature becomes close to the melting point of its matrix resin, which is a feature distinguishable from conventional molded articles.

To summarize the features of the composite molded article (C) of the present invention, it is preferred that the composite molded article (C) of the present invention has at least one of the following features (1) to (4), in addition to the feature that the area under a stress-strain curve of the composite molded article (C) of the present invention (AUC1) is at least two times the area under a stress-strain curve of the melt-molded article (D) having the same composition as that of the composite molded article (C) (AUC2):
(1) the tensile elastic modulus of the composite molded article (C) (EMc) is at least 1.05 times the tensile elastic modulus of the melt-molded article (D) having the same composition as that of the composite molded article (C) (EMd);
(2) the tensile strength of the composite molded article (C) is at least 1.2 times the tensile strength of the melt-molded article (D) having the same composition as that of the composite molded article (C);
(3) the breaking strain of the composite molded article (C) is at least two times the breaking strain of the melt-molded article (D) having the same composition as that of the composite molded article (C); and
(4) the coefficient of linear thermal expansion (CTE) at 40° C. to 80° C. of the composite molded article (C) is −5 to 147 (ppm/K).

Thus, the composite molded article (C) has excellent strength and elastic modulus, as well as dramatically improved elongation. Further, the composite molded article (C) has excellent dimensional stability due to its low coefficient of linear thermal expansion.

### 3. Cellulosic Nanomaterial (A)

The cellulosic nanomaterial (A) preferably has a fiber diameter within the range of 1 nm to 10 μm, more preferably 1 nm to 1 μm, and even more preferably 1 nm to 500 nm. The shape of the cellulosic nanomaterial (A) may be fibrous, powdery, needle-like, rod-like, or the like.

For the excellent properties of the composite molded article (C), at least one member selected from the group consisting of microfibrillated cellulosic fibers, fine cellulosic powders, and cellulose nanocrystals is preferably used for the cellulosic nanomaterial (A). The cellulosic nanomaterial (A) may contain lignin. Its hydroxyl groups may be chemically modified.

The microfibrillated cellulosic fibers preferably have a fiber diameter within the range of 1 nm to 10 μm, more preferably 1 nm to 1 μm, and even more preferably 1 nm to 500 nm. The microfibrillated cellulosic fibers preferably have a fiber length of 5 μm or more, and more preferably about 5 μm to 100 μm. The microfibrillated cellulosic fibers may contain lignin. Their hydroxyl groups may be chemically modified.

The microfibrillated cellulosic fibers do not all have to be uniformly microfibrillated. For example, cellulosic fibers in which the diameter of the thick part (trunk part) of the fiber is 5 μm, and one or more thin parts (branch parts) having a diameter of about 10 nm are present on its surface are also referred to as microfibrillated cellulosic fibers, and can be preferably used in the present invention.

Examples of microfibrillated cellulosic fibers include (1) cellulose nanofibers (CNF), (2) lignocellulose nanofibers (ligno-CNF), and (3) a cellulosic nanomaterial (A) that is not CNF, ligno-CNF, fine cellulosic powders, or cellulose nanocrystals.

The cellulose nanofibers may have an average fiber width of 4 nm to 100 nm and an average length of 5000 nm or more. The lignocellulose nanofibers are cellulose nanofibers containing lignin.

The fine cellulosic powder may have a major axis and a minor axis that are each 300 nm to 3000 nm. The fine cellulosic powder may be cellulose crystals or amorphous cellulose. The fine cellulosic powder may contain lignin. Its hydroxyl groups may be chemically modified.

The cellulose nanocrystals are cellulose crystals and contain no lignin. The cellulose nanocrystals may be cellulose crystals having an average width of 10 nm to 50 nm and an average length of 100 nm to 500 nm. The cellulose nanocrystals may have chemically modified hydroxyl groups.

Chemical modification means that some of the hydroxyl groups of the sugar chains and/or lignin constituting the cellulosic nanomaterial (A) (sometimes referred to as “the hydroxyl groups of the cellulosic nanomaterial (A)” in the present specification) are modified with one or more other groups. The chemical modifications (i) to (iii) below are preferred in that they enable the cellulosic nanomaterial (A) to be well dispersed in the composite molded article (C).
(i) Some of the hydroxyl groups of the cellulosic nanomaterial (A) are esterified with a carboxylic acid represented by the following formula (1). Specifically, when a hydroxyl group is esterified with the carboxylic acid represented by the following formula (1), the hydroxyl group is converted to —O—CO—R.

R—COOH (1)
wherein R represents (a) an alkyl or alkenyl group, (b) an optionally crosslinked or fused alicyclic hydrocarbon group, (c) an oxyalkyl group substituted with an optionally crosslinked or fused alicyclic hydrocarbon group, or (d) a phenoxyalkyl group, an alkyl-substituted phenoxyalkyl group, or a phenoxyalkyl group substituted with an optionally crosslinked or fused alicyclic hydrocarbon group.
(ii) Some of the hydroxyl groups of the cellulosic nanomaterial (A) are half-esterified with an alkyl or alkenyl succinic anhydride (ester bond with one carbonyl of a succinic anhydride group). “Half-esterification” as used herein means that only one of the two carbonyl groups of an alkyl or alkenyl succinic anhydride reacts with a hydroxyl group of the cellulosic nanomaterial (A) to form an ester bond.
(iii) Hydrogen atom(s) of some of the hydroxyl groups of the cellulosic nanomaterial (A) are replaced by a carboxymethyl group, a carboxyethyl group, a hydroxyethyl group, a 2-hydroxypropyl group, or a cyanoethyl group to form ether bond(s). For example, when the hydrogen atom of a hydroxyl group is replaced by a carboxymethyl group, the hydroxyl group is converted to —O—CH₂—COOH.

In the carboxylic acid represented by formula (1) in which R is (a) an alkyl or alkenyl group, the alkyl group and the alkenyl group may be linear or branched. The number of carbon atoms in each of the alkyl group and the alkenyl group may be, for example, 1 to 17, 1 to 12, 1 to 10, 1 to 6, 1 to 4, 1 to 3, 1 to 2, or 1.

R is preferably a C₁₋₁₇ alkyl or alkenyl group, and more preferably a C₁₋₁₇ alkyl group. R is preferably a methyl group, an ethyl group, an iso-butyl group, a t-butyl group, an n-undecyl group, an n-tridecyl group, an n-pentadecyl group, an n-heptadecyl group, or the like, and more preferably a t-butyl group.

The carboxylic acid represented by formula (1) in which R is (a) an alkyl or alkenyl group is preferably acetic acid, propionic acid, 2-methylbutanoic acid, pivalic acid, lauric acid, myristic acid, palmitic acid, stearic acid, or the like, and more preferably pivalic acid. Acetic acid is also more preferable from the viewpoint of production cost.

In the carboxylic acid represented by formula (1) in which R is (b) an optionally crosslinked or fused alicyclic hydrocarbon group, R is preferably an adamantyl group, cyclohexyl group, 4-(t-butyl)cyclohexyl group, or the like, and more preferably an adamantyl group.

In the carboxylic acid represented by formula (1) in which R is (c) an oxyalkyl group substituted with an optionally crosslinked or fused alicyclic hydrocarbon group, R is preferably a bornyloxymethyl group, isobornyloxymethyl group, a menthyl group, or the like.

In the carboxylic acid represented by formula (1) in which R is (d) a phenoxyalkyl group, an alkyl-substituted phenoxyalkyl group, or a phenoxyalkyl group substituted with an optionally crosslinked or fused alicyclic hydrocarbon group, the alkyl group may be linear or branched. The number of carbon atoms in the alkyl group may be, for example, 1 to 17, 1 to 12, 1 to 10, 1 to 6, 1 to 4, 1 to 3, 1 to 2, 1, or the like. R is preferably a phenoxymethyl group, 4-(t-butyl)phenoxymethyl group, 4-(1,1,3,3-tetramethyl)butylphenoxymethyl group, adamantylphenoxymethyl group, bornylphenoxymethyl group, bornylphenoxypentyl group, menthylphenoxymethyl group, or the like, and more preferably a 4-(t-butyl) phenoxymethyl group, 4-(1,1,3,3-tetramethyl)butylphenoxymethyl group, adamantylphenoxymethyl group, bornylphenoxymethyl group, menthylphenoxymethyl group, or the like.

In the half-esterification of (ii), the alkyl or alkenyl succinic anhydride means an alkyl succinic anhydride or alkenyl succinic anhydride. Here, alkyl and alkenyl may be linear or branched. In the present invention, alkyl succinic anhydrides and alkenyl succinic anhydrides may be used singly or in a combination of two or more.

The alkenyl succinic anhydride (also referred to as “ASA” in the present specification) may be a compound composed of a skeleton derived from a C₄₋₁₈ olefin that may have one or more branched chains and a succinic anhydride skeleton. Preferred examples of ASAs include pentenyl succinic anhydride, hexenyl succinic anhydride, octenyl succinic anhydride, decenyl succinic anhydride, undecenyl succinic anhydride, dodecenyl succinic anhydride, tridecenyl succinic anhydride, tetradecenyl succinic anhydride, hexadecenyl succinic anhydride, octadecenyl succinic anhydride, and iso-octadecenyl succinic anhydride. The ASAs may be used singly or in a combination of two or more.

In the present specification, an alkenyl succinic anhydride containing an olefin chain having a specific number of carbon atoms may be denoted by a combination of ASA, which is an abbreviation for alkenyl succinic anhydride, and the number of carbon atoms in the olefin chain. For example, an alkenyl succinic anhydride containing a C₁₆ olefin chain (hexadecenyl succinic anhydride) may be denoted as “ASA-C16.”

In the present specification, an ASA may also be denoted by a trade name or product code number. Examples include AS1533 (produced by Seiko PMC Corporation), TNS135 (produced by Seiko PMC Corporation), Rikacid DDSA (tetrapropenyl succinic anhydride (3-dodecenyl succinic anhydride) produced by New Japan Chemical Co., Ltd.), DSA (produced by Sanyo Chemical Industries, Ltd.), and PDSA-DA (produced by Sanyo Chemical Industries, Ltd.). These listed ASAs can also be suitably used in the present invention.

Of the alkyl or alkenyl succinic anhydride used in the half-esterification of (ii), the alkyl succinic anhydride is one having a structure in which the unsaturated bond of the alkenyl group of an ASA described above is reduced by hydrogenation (i.e., succinic anhydride in which the alkenyl group of an ASA is converted to an alkyl group). For example, alkyl succinic anhydrides in which the alkenyl group in each of the compounds specifically mentioned above as ASAs is converted to an alkyl group can also be suitably used for the half-esterification.

More preferred examples of alkyl succinic anhydrides include octyl succinic anhydride, dodecyl succinic anhydride, tridecenyl succinic anhydride, tetrahexadecyl succinic anhydride, hexadecyl succinic anhydride, octadecyl succinic anhydride, and the like.

The degree of chemical modification in the cellulosic nanomaterial (A) is generally denoted as degree of substitution or DS. The degree of substitution (DS) is the average number of hydroxyl groups in the repeating unit of the cellulosic nanomaterial (A) that are chemically modified. The repeating unit of cellulose that does not contain lignin is a glucopyranose residue (glucose residue), which has three hydroxyl groups. Thus, the upper limit of the degree of substitution in pure cellulose is 3.

Cellulose containing lignin contains hemicellulose and lignin together with cellulose. The number of hydroxyl groups in the repeating unit (xylose residue) in xylan contained in hemicellulose and the number of hydroxyl groups in the repeating unit (galactose residue) in arabinogalactan contained in hemicellulose are 2, and the number of hydroxyl groups in the lignin residue is 2. The number of hydroxyl groups per each of these repeating units is less than 3. Thus, the average number of hydroxyl groups in each repeating unit of cellulose containing lignin is less than 3. Thus, the upper limit of the degree of substitution of cellulose containing lignin is about 2.7 to 2.8, depending on the hemicellulose content and lignin content of the cellulose.

The degree of substitution (DS) can be analyzed by using various analytical methods, such as elementary analysis, neutralization titration method, FT-IR, and two-dimensional NMR (¹H and ¹³C-NMR).

When the chemical modification is the esterification of (i) described above or the half-esterification of (ii) described above, the degree of substitution is preferably about 0.05 to 2, more preferably about 0.1 to 1.7, and even more preferably about 0.15 to 1.5.

When the chemical modification is substitution with a hydroxyethyl group, a 2-hydroxypropyl group, or a cyanoethyl group in (iii) described above, the degree of substitution is preferably about 0.1 to 1.5, and more preferably about 0.2 to 1.2.

When the chemical modification is substitution with a carboxymethyl group or a carboxyethyl group in (iii) described above, the degree of substitution is preferably about 0.01 to 0.4, and more preferably about 0.01 to 0.3.

The chemically modified cellulosic nanomaterial (A) having a degree of substitution within the above range has appropriate crystallinity and solubility parameter (SP) and is thus uniformly dispersed in the matrix (thermoplastic resin). Thus, the composite molded article (C) containing the chemically modified cellulosic nanomaterial (A) having a degree of substitution within the above range has, for example, more excellent strength, elastic modulus, and elongation, and low thermal expansion.

### 4. Thermoplastic Resin (B)

The matrix of the composite molded article (C) is the thermoplastic resin (B). Examples of the thermoplastic resin (B) include polyolefins, polyamides, aliphatic polyesters, aromatic polyesters, polyacetals, polycarbonates, polystyrene, (meth)acrylic resins, acrylonitrile-butadiene-styrene copolymers (ABS resins), polycarbonate-ABS alloys (PC-ABS alloys), modified polyphenylene ethers (m-PPE), vinyl chloride resins, cellulosic resins, polylactic acid (PLA), polyhydroxybutyrate (PHBT), polyhydroxyhexanoate (PRAT), copolymers of polyhydroxybutyrate and polyhydroxyhexanoate (PHBH), polybutylene succinate (PBS), and the like. These may be used singly or in a combination of two or more.

Among these, cellulosic resins, polylactic acid (PLA), polyhydroxybutyrate (PHBT), polyhydroxyhexanoate (PHAT), copolymers of polyhydroxybutyrate and polyhydroxyhexanoate (PHBH), and polybutylene succinate (PBS) are biodegradable thermoplastic resins.

Preferred examples of the thermoplastic resin (B) include polyolefins, polyamides, polyacetals, polycarbonates, and the like, with polyolefins, polyamides, and the like being more preferable, and polyolefins being particularly preferable.

The polyolefins include polyethylene and polypropylene of various densities, as well as copolymers of ethylene and olefins other than ethylene, such as copolymers of ethylene and propylene, and copolymers of ethylene and butylene. Preferred polyolefins are polypropylene, polyethylene, and the like, and for carbon neutrality, polyolefins made from biomass, such as bio-polyethylene and bio-polypropylene, are preferable.

To obtain the composite molded article (C) having desired physical properties of the present invention, the thermoplastic resin (B) is preferably (1) at least one crystalline thermoplastic resin selected from the group consisting of polyolefins, polyamides, aliphatic polyesters, aromatic polyesters, polyacetals, polycarbonates, polystyrene, (meth)acrylic resins, acrylonitrile-butadiene-styrene copolymers (ABS resins), polycarbonate-ABS alloys (PC-ABS alloys), modified polyphenylene ethers (m-PPE), vinyl chloride resins, cellulosic resins, polylactic acid (PLA), polyhydroxybutyrate (PHBT), polyhydroxyhexanoate (PHAT), copolymers of polyhydroxybutyrate and polyhydroxyhexanoate (PHBH), and polybutylene succinate (PBS), or (2) a mixture of at least one crystalline thermoplastic resin selected from the group described above and at least one amorphous thermoplastic resin selected from the group described above.

Examples of crystalline thermoplastic resins include polyethylene, polypropylene, polyamides, polyacetals (polyoxymethylene), polyethylene terephthalate, polybutylene terephthalate, polyphenylene sulfide (PPS), polyether ether ketone, and the like, with polyethylene, polypropylene, and polyamides being preferable.

Examples of amorphous thermoplastic resins include vinyl chloride resins, polystyrene, polymethyl methacrylate, acrylonitrile-butadiene-styrene-copolymers (ABS resins), polycarbonates, modified polyphenylene ethers (m-PPE), polyethersulfone (PESU), polyetherimide (PEI), polyamide-imide (PAI), and the like, with vinyl chloride resins, polystyrene, and polymethyl methacrylate being preferable.

The content of the cellulosic nanomaterial (A) in the composite molded article (C) is, for example, 1 to 70 mass, preferably 1 to 50 masse, more preferably 1 to 30 mass %, and even more preferably 1 to 10 mass %, based on the mass of the composite molded article, from the viewpoint of ease of production and low production cost. This content (mass %), when a chemically modified cellulosic nanomaterial (A) is used, is calculated from the mass in terms of the cellulosic nanomaterial that is not chemically modified. The same applies to the production method of the present invention.

The content of the thermoplastic resin (B) in the composite molded article (C) is, for example, 30 to 99 mass %, preferably 50 to 99 mass %, more preferably 70 to 99 mass %, and even more preferably 90 to 99 mass %, based on the mass of the composite molded article, from the viewpoint of ease of production and low production cost.

The composite molded article (C) may contain other components in addition to the cellulosic nanomaterial (A) and the thermoplastic resin (B) as long as the effects of the present invention are not impaired. Examples of other components include compatibilizers, inorganic fillers, antioxidants, light stabilizers, and the like, with compatibilizers, inorganic fillers, and the like being preferable.

Examples of compatibilizers include resins into which polar groups are introduced by adding maleic anhydride, epoxy, etc. to thermoplastic resins, such as maleic anhydride-modified polyethylene resins (PE), maleic anhydride-modified polypropylene resins (PP), and commercially available compatibilizers. The compatibilizers may be used singly or in a combination of two or more. Preferred examples of compatibilizers include maleic anhydride-modified PE, maleic anhydride-modified PP, and the like.

When the composite molded article (C) contains a compatibilizer, the content of the compatibilizer is preferably 1 to 40 mass %, and more preferably 1 to 20 mass %, based on the mass of the thermoplastic resin (B).

Examples of inorganic fillers include talc, clay, zeolite, aluminum oxide, calcium carbonate, titanium oxide, silica, magnesium oxide, and the like. The inorganic fillers may be used singly or in a combination of two or more. Preferred examples of inorganic fillers include talc, calcium carbonate, magnesium oxide, and the like.

When the composite molded article (C) contains an inorganic filler, the content of the inorganic filler is preferably 0.1 to 10 mass %, and more preferably 1 to 5 mass %, based on the mass of the composite molded article.

When the composite molded article (C) contains a component other than compatibilizers and inorganic fillers, the content of the other component is preferably 0.1 to 10 mass %, and more preferably 1 to 5 mass %, based on the mass of the composite molded article.

### 5. Method for Producing Composite Molded Article (C)

The composite molded article (C) comprising the cellulosic nanomaterial (A) and the thermoplastic resin (B) can be produced by a production method comprising the following steps 1 to 3.

Specifically, first, a composition comprising the cellulosic nanomaterial (A) and the thermoplastic resin (B) is melted to prepare a molten composite composition comprising the cellulosic nanomaterial (A) and the thermoplastic resin (B) (step 1). Next, the molten composite composition obtained in step 1 is melted, molded, and cooled to prepare a melt-molded article (D) (step 2). Then, the melt-molded article (D) obtained in step 2 is warm-formed by at least one method selected from the group consisting of shearing, compression, stretching, and rolling (step 3), thereby producing the composite molded article (C).

In step 1, a composition comprising the cellulosic nanomaterial (A) and the thermoplastic resin (B) is melted. The amount of the cellulosic nanomaterial (A) in the composition is 1 to 70 mass %, preferably 1 to 50 mass %, more preferably 1 to 30 mass %, and even more preferably 1 to 10 mass %, based on the total mass of the cellulosic nanomaterial (A) and the thermoplastic resin (B), from the viewpoint of ease of production and low production cost.

When the composite molded article comprises a component described above other than the cellulosic nanomaterial (A) and the thermoplastic resin (B), the other component may be contained in the composition or added at a later stage in the production process, and it is preferred that the other component is contained in the composition.

Melting of the composition in step 1 can be performed by heating the composition. By melting, a molten composite composition can be prepared. The heating temperature is equal to or higher than the melting point of the thermoplastic resin (B). The heating temperature is preferably at least 0.5° C. higher than the melting point of the thermoplastic resin (B). To avoid damage to the cellulosic nanomaterial (A), decomposition of the thermoplastic resin, etc., the heating temperature is preferably 250° C. or lower. The heating temperature may be in the range of from the melting point of the thermoplastic resin (B) to a temperature that is 5° C. higher than the melting point of the thermoplastic resin (B), or in the range of from the melting point of the thermoplastic resin (B) to a temperature that is 10° C. higher than the melting point of the thermoplastic resin (B).

The composition comprising the cellulosic nanomaterial (A) and the thermoplastic resin (B) may be melted while performing a mixing operation, such as stirring or kneading the mixture of the cellulosic nanomaterial (A) and the thermoplastic resin (B).

If the molten composite composition prepared in step 1 is not in a molten state, it is melt, and the resulting melt is molded and cooled to prepare a melt-molded article (D) in step 2. A method in which the composite composition in a molten state obtained by melting the composition comprising the cellulosic nanomaterial (A) and the thermoplastic resin (B) in step 1 is molded and cooled to prepare a melt-molded article (D) in step 2 is preferred as an efficient production method.

The melt-molded article (D) prepared in step 2 is processed in step 3. The processing is preferably warm-forming by at least one method selected from the group consisting of shearing, compression, stretching, and rolling. Compression here encompasses compressing the melt-molded article (D) after injection. Rolling, compression, shearing, etc. are preferred processing methods, and methods using a combination of rolling, compression, shearing, etc. are more preferred.

The composite molded article (C) may be produced by subjecting the melt-molded article (D) to shearing, compression, stretching, rolling, or the like, and these processing methods may be used singly or in a combination of two or more. Compression here encompasses compressing the melt-molded article (D) after injection. The processing method is preferably at least one member selected from the group consisting of rolling, shearing, and compression.

In the above method, a melt-molded article (D) is prepared in step 2, and the melt-molded article (D) is warm-formed to produce a composite molded article (C) in step 3. However, a method in which an injection-molded article is prepared in place of the melt-molded article (D) and warm-formed to produce a composite molded article (C) is suitable for quickly producing the composite molded article (C) in large quantities.

That is, first, a composition comprising the cellulosic nanomaterial (A) and the thermoplastic resin (B) is melted to prepare a molten composite composition comprising the cellulosic nanomaterial (A) and the thermoplastic resin (B) (step 1). Next, the molten composite composition obtained in step 1 is injection-molded to prepare an injection-molded article (E) (step 2). The injection-molded article (E) obtained in step 2 is warm-formed by at least one method selected from the group consisting of shearing, compression, stretching, and rolling (step 3), thereby efficiently producing a composite molded article (C). The present invention may also encompass such an embodiment.

To obtain a composite article (C) having good physical properties, it is preferred that when the thermoplastic resin (B) is a crystalline resin, the temperature in the warm-forming is less than the melting point of the crystalline resin; that when the thermoplastic resin (B) is an amorphous resin, the temperature in the warm-forming is less than the glass transition temperature of the amorphous resin; and that when the thermoplastic resin (B) is a mixture of a crystalline resin and an amorphous resin, the temperature in the warm-forming is less than the melting point of the crystalline resin.

In the warm-forming, it is preferred that pressure is applied under conditions in which the ratio of the thickness of the composite molded article (C) (Ct) to the thickness of the melt-molded article (D) (Dt) (Ct/Dt) becomes 0.1 to 0.9, and preferably 0.1 to 0.8, in order to obtain a composite article (C) having good physical properties. Thus, the conditions for each processing process may be adjusted so that (Ct/Dt) is within the above range.

### EXAMPLES

The present invention is described below in more detail with reference to Examples and Comparative Examples. However, the present invention is not limited to these Examples. In the Examples and the Comparative Examples, % in the content of each component refers to mass %, unless otherwise specified.

In the claims and the specification, Dt is used as the symbol for the thickness of the melt-molded article (D) before warm-forming, and Ct is used as the symbol for the thickness of the composite molded article (C), which is obtained by subjecting the melt-molded article (D) to warm-forming. However, in the following Examples etc., T₀ may be used as the symbol for the thickness of the material to be subjected to rolling (i.e., the molded article before rolling), and T₁ may be used as the symbol for the thickness of the molded article after rolling.

### Experimental Materials

Polypropylene (masterbatch, Seiko PMC Corporation) containing 10 mass % of cellulose nanofibers (CNF) chemically modified with an alkenyl succinic anhydride (ASA) was mixed with polypropylene (PP) (Novatec PP, MA04A, Japan Polypropylene Corporation), followed by melting and kneading, thereby preparing polypropylene (PP) composite material pellets (molten composite composition) containing 5.9 mass % of cellulose nanofibers (CNF). The composite material pellets were injection-molded to form a flat plate sample (120 mm×62 mm×2 mm) (injection-molded flat plate sample (Comparative Example 1)), and the obtained flat plate sample was cut to prepare samples for rolling (60 mm×60 mm×2 mm, and 30 mm×30 mm×2 mm) or a sample for melting (a sample for preparing a melt-molded article, 30 mm×30 mm×2 mm).

### Rolling

Each sample for rolling was sandwiched between Teflon sheets coated with a release agent, and rolled using a 37-ton hot press (NF-37, Shinto Metal Industries, Ltd.) or a 300-ton hot press (TA-300-1W, Yamamoto Eng. Works Co., Ltd.). The sample after rolling had a substantially elliptical shape. When applying a low load to a sample (Example 1), the 37-ton hot press was used, and when applying a high load to a sample (Examples 2 to 12), the 300-ton hot press was used. The rolling temperature was set to 120° C. To evaluate the degree of rolling, the rolling rate was expressed as follows:

Rolling rate (%)=100×(T₀−T₁)/T₀
wherein T₀=initial plate thickness, and T₁=plate thickness after rolling.

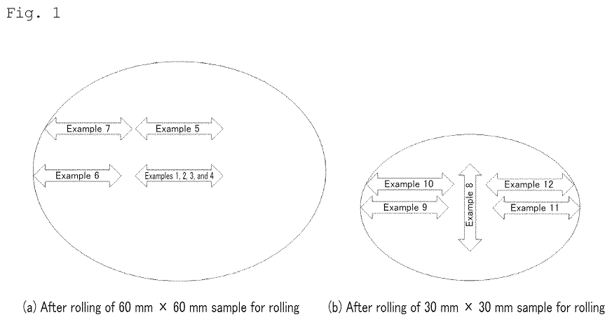

When a sample for rolling is rolled using a press, the physical properties vary depending on the position and direction in the sample due to friction between the sample and the Teflon sheets. Thus, as shown in FIG. 1, test pieces used for measuring tensile properties and thermal properties were cut out at different positions and directions in the rolled samples (substantially elliptical) and subjected to measurement. In Example 1, Example 2, and Example 3, different rolling loads (88 kN, 263 kN, and 940 kN) were applied to three samples for rolling (60 mm×60 mm×2 mm), respectively, and test pieces cut out from the center of the rolled samples were evaluated. In Example 4, Example 5, Example 6, and Example 7, a load (2986 kN) was applied to the same sample for rolling (60 mm×60 mm×2 mm) repeatedly (six times), and test pieces were obtained from different positions of the rolled sample. In Example 8, Example 9, Example 10, Example 11, and Example 12, a load (926 kN) was applied to the same sample for rolling (30 mm×30 mm×2 mm) repeatedly (six times), and test pieces were obtained from different positions and directions of the rolled sample.

### Preparation of Melt-Molded Article

The sample for melting (the composition of this sample corresponds to that of Example 10; 30 mm×30 mm×2 mm) was sandwiched between polyethylene terephthalate films, melted at 200° C. using a hot press, and cooled under increased pressure to the extent that this melt was not deformed, thereby preparing a melt-molded article (Comparative Example 2).

### Tensile Test Method

Dumbbell-shaped test pieces (JIS K6251, No. 8 dumbbell shape) were prepared from the rolled samples, the injection-molded flat plate sample before rolling (Comparative Example 1), and the melt-molded article (Comparative Example 2) using a die cutter. The test piece of the injection-molded flat plate sample (Comparative Example 1) (120 mm×62 mm×2 mm) was obtained from the center portion in the lateral (62 mm) direction and from the lateral direction (same direction as that in Example 1). The test piece of the melt-molded article (Comparative Example 2) was obtained from any position and direction since the polypropylene (PP) molecules and chemically modified cellulose nanofibers (CNF) contained in the melt-molded article were not oriented. The prepared test pieces were dumbbell-shaped test pieces (JIS K6251, No. 8 dumbbell shape). Tensile tests were performed using a universal testing machine (Instron 3365, Instron Japan) at a tensile speed of 10 mm/min. The tensile elastic modulus was determined from the linear regression slope of a stress-strain curve between 0.05% and 0.25% strain. The tensile strength is the maximum stress, and the breaking strain is the strain at break. The area under the stress-strain curve was determined by dividing the area between the curve and the strain axis into many trapezoids and summing the areas of them using Microsoft Excel software. Specifically, these areas approximately correspond to the integral of the stress-strain curve from a strain of 0 to the breaking strain.

### Method for Measuring Coefficient of Linear Thermal Expansion (CTE)

The rolled samples, the injection-molded flat plate sample before rolling (Comparative Example 1), and the melt-molded article (Comparative Example 2) were cut to 30 mm long×2 mm wide, and the CTE was measured using a thermomechanical analyzer (TMA/SS6100, SII NanoTechnology, Inc.). A tensile stress of 4 kPa was applied to the samples, and the CTE was measured under a nitrogen atmosphere at a temperature increase rate of 5° C./min. The CTE in the range of 40° C. to 80° C. was determined.

FIG. 2 shows stress-strain curves of representative samples (Examples 5 and 10, and Comparative Example 2). By rolling, the strength and breaking strain were increased, and the area under the stress-strain curve was increased.

Table 1 summarizes the measured physical properties. For comparison, tensile tests and CTE measurements were also performed for the injection-molded sample (Comparative Example 1) and the melt-molded article (Comparative Example 2: the composition of this molded article corresponds to that of Example 10) before rolling. Table 1 also shows the ratios (tensile elastic modulus ratio, tensile strength ratio, breaking strain ratio, area ratio under the stress-strain curve, and CTE ratio) of each rolled sample to the melt-molded article (Comparative Example 2). Note that the thickness ratio in the table refers to the ratio of the sample thickness after rolling to the sample thickness before rolling.

TABLE 1

| | | | Thickness | Thickness | | | | | |
|---|---|---|---|---|---|---|---|---|---|
| | | | before | after | | | | Elastic | |
| | | | rolling | rolling | Thickness | Rolling | Elastic | modulus | |
| | Sample | Load | T₀ | T₁ | ratio | rate | modulus | ratio | Strength |
| | size | (kN) | (mm) | (mm) | (T₁/T₀) | (%) | (GPa) | Emc/Emd | (MPa) |
| Ex. 1 | 60 × 60 | 88 | 1.854 | 1.400 | 0.76 | 24 | 2.95 | 1.3 | 44.0 |
| | mm | | | | | | | | |
| Ex. 2 | 60 × 60 | 263 | 1.891 | 1.046 | 0.55 | 45 | 3.29 | 1.4 | 58.3 |
| | mm | | | | | | | | |
| Ex. 3 | 60 × 60 | 940 | 1.867 | 0.851 | 0.46 | 54 | 3.79 | 1.6 | 66.0 |
| | mm | | | | | | | | |
| Ex. 4 | 60 × 60 | 2986 | 1.869 | 0.721 | 0.39 | 61 | 3.50 | 1.5 | 52.9 |
| Ex. 5 | mm | (6 times) | 1.869 | 0.612 | 0.33 | 67 | 3.19 | 1.4 | 53.2 |
| Ex. 6 | | | 1.869 | 0.364 | 0.19 | 81 | 4.04 | 1.7 | 119.3 |
| Ex. 7 | | | 1.869 | 0.362 | 0.19 | 81 | 3.72 | 1.6 | 133.8 |
| Ex. 8 | 30 × 30 | 926 | 1.867 | 0.529 | 0.28 | 72 | 3.16 | 1.4 | 50.8 |
| Ex. 9 | mm | (6 times) | 1.867 | 0.191 | 0.10 | 90 | 5.29 | 2.3 | 195.7 |
| Ex. 10 | | | 1.867 | 0.195 | 0.10 | 90 | 5.62 | 2.4 | 206.6 |
| Ex. 11 | | | 1.867 | 0.189 | 0.10 | 90 | 4.94 | 2.1 | 195.8 |
| Ex. 12 | | | 1.867 | 0.194 | 0.10 | 90 | 5.01 | 2.2 | 201.4 |
| Comp. | | | 1.923 | 1.923 | 1.00 | 0 | 2.69 | 1.2 | 36.4 |
| Ex. 1 | | | | | | | | | |
| Injection | | | | | | | | | |
| molding | | | | | | | | | |
| Comp. | | | 0.302 | 0.302 | 1.00 | 0 | 2.31 | 1.0 | 32.3 |
| Ex. 2 | | | | | | | | | |
| Melt | | | | | | | | | |
| molding | | | | | | | | | |

| | | | | Area | | | |
|---|---|---|---|---|---|---|---|
| | | Breaking | | under | | | |
| | Strength | strain | Strain | curve | Area ratio | CTE | CTE |
| | ratio | (%) | ratio | (MPa %) | AUC1/AUC2 | (ppm/K) | ratio |
| Ex. 1 | 1.4 | 11.6 | 2.9 | 442 | 4.6 | | |
| Ex. 2 | 1.8 | 34.0 | 8.4 | 1790 | 18.5 | 146.9 | 0.86 |
| Ex. 3 | 2.0 | 30.9 | 7.7 | 1785 | 18.5 | 85.3 | 0.50 |
| Ex. 4 | 1.6 | 49.7 | 12.3 | 2444 | 25.3 | 126.9 | 0.74 |
| Ex. 5 | 1.6 | 137.3 | 34.0 | 6707 | 69.3 | 130.6 | 0.76 |
| Ex. 6 | 3.7 | 18.6 | 4.6 | 1544 | 16.0 | 108.8 | 0.63 |
| Ex. 7 | 4.1 | 24.5 | 6.1 | 2345 | 24.2 | 85.0 | 0.50 |
| Ex. 8 | 1.6 | 81.3 | 20.1 | 3891 | 40.2 | 60.3 | 0.35 |
| Ex. 9 | 6.1 | 20.6 | 5.1 | 2654 | 27.4 | 16.7 | 0.10 |
| Ex. 10 | 6.4 | 21.4 | 5.3 | 2911 | 30.1 | 24.9 | 0.15 |
| Ex. 11 | 6.1 | 17.7 | 4.4 | 2203 | 22.8 | −4.8 | −0.03 |
| Ex. 12 | 6.2 | 21.0 | 5.2 | 2764 | 28.6 | 66.1 | 0.39 |
| Comp. | 1.1 | 3.9 | 1.0 | 105 | 1.1 | | |
| Ex. 1 | | | | | | | |
| Injection | | | | | | | |
| molding | | | | | | | |
| Comp. | 1.0 | 4.0 | 1.0 | 97 | 1.0 | 171.5 | 1.00 |
| Ex. 2 | | | | | | | |
| Melt | | | | | | | |
| molding | | | | | | | |

A comparison of Examples 1 to 4 reveals that an increase in the rolling load (or a decrease in the sample thickness) increased the area under the stress-strain curve (AUC1) and decreased the CTE. A comparison of Examples 4 to 7 reveals that high elasticity, high strength, and low CTE were exhibited in the highly stretched regions and directions (regions away from the center of the sample and in the more stretched directions). On the other hand, high breaking strain was exhibited in the low-stretch regions and directions (center regions of the sample and low-stretch directions). A comparison of Examples 8 to 12 reveals that a further increase in the rolling stress (rolling load/sample area before rolling) or decrease in the sample thickness further increased the tensile elastic modulus and the tensile strength.

As shown above, the area under the stress-strain curve of the composite molded article of the present invention (AUC1) was at least four times the area under the stress-strain curve of the melt-molded article (Comparative Example 2) having the same composition as that of the composite molded article (AUC2). The tensile elastic modulus of the composite molded article of the present invention (EMc) was at least 1.3 times the tensile elastic modulus of the melt-molded article having the same composition as that of the composite molded article (EMd). The tensile strength of the composite molded article of the present invention was at least 1.4 times the tensile strength of the melt-molded article having the same composition as that of the composite molded article. The breaking strain of the composite molded article of the present invention was at least two times the breaking strain of the melt-molded article having the same composition as that of the composite molded article. The coefficient of linear thermal expansion (CTE) of the composite molded article of the present invention was less than the CTE of the melt-molded article having the same composition as that of the composite molded article. It was also found that the composite molded article of the present invention has the characteristic of contracting when the temperature becomes close to the melting point of its matrix resin.

1. A composite molded article (C) comprising a cellulosic nanomaterial (A) and a thermoplastic resin (B), an area under a stress-strain curve of the composite molded article (C) (AUC1) being at least two times an area under a stress-strain curve of a melt-molded article (D) having the same composition as that of the composite molded article (C) (AUC2),
wherein the stress-strain curve is a curve drawn with strain (unit: %) on the horizontal axis and stress (unit: MPa) on the vertical axis and obtained by subjecting the composite molded article (C) or the melt-molded article (D) to a tensile test, and the area is an area up to the horizontal axis from under a curved portion of the curve that is from the origin (stress: 0) of the stress-strain curve to a fracture of the composite molded article (C) or the melt-molded article (D).

2. The composite molded article (C) according to claim 1, wherein the composite molded article (C) is at least one molded article selected from the group consisting of warm-sheared molded articles, warm-compressed molded articles, warm-stretched molded articles, and warm-rolled molded articles, of the melt-molded article (D).

3. The composite molded article (C) according to claim 1, wherein the composite molded article (C) has a tensile elastic modulus (EMc) that is at least 1.05 times a tensile elastic modulus of the melt-molded article (D) having the same composition as that of the composite molded article (C) (EMd).

4. The composite molded article (C) according to claim 1, wherein the composite molded article (C) has at least one of the following features (1) to (4):
(1) the composite molded article (C) has a tensile elastic modulus (EMc) that is at least 1.05 times a tensile elastic modulus of the melt-molded article (D) having the same composition as that of the composite molded article (C) (EMd),
(2) the composite molded article (C) has a tensile strength that is at least 1.2 times a tensile strength of the melt-molded article (D) having the same composition as that of the composite molded article (C),
(3) the composite molded article (C) has a breaking strain that is at least two times a breaking strain of the melt-molded article (D) having the same composition as that of the composite molded article (C), and
(4) the composite molded article (C) has a coefficient of linear thermal expansion (CTE) at 40° C. to 80° C. of −5 to 147 (ppm/K).

5. The composite molded article (C) according to claim 1, wherein the cellulosic nanomaterial (A) is at least one cellulosic nanomaterial selected from the group consisting of microfibrillated cellulosic fibers, fine cellulosic powders, and cellulose nanocrystals, all of which are optionally chemically modified.

6. The composite molded article (C) according to claim 5, wherein the cellulosic nanomaterial (A) is at least one cellulosic nanomaterial in which some of the hydroxyl groups of sugar chains and/or lignin constituting the material are modified with at least one chemical bond selected from the group consisting of the following (i) to (iii), the at least one cellulosic nanomaterial being selected from the group consisting of microfibrillated cellulosic fibers, fine cellulosic powders, and cellulose nanocrystals:
(i) an ester bond with a carboxylic acid represented by the following formula (1):
R—COOH (1)
wherein R represents (a) an alkyl or alkenyl group, (b) an optionally crosslinked or fused alicyclic hydrocarbon group, (c) an oxyalkyl group substituted with an optionally crosslinked or fused alicyclic hydrocarbon group, or (d) a phenoxyalkyl group, an alkyl-substituted phenoxyalkyl group, or a phenoxyalkyl group substituted with an optionally crosslinked or fused alicyclic hydrocarbon group,
(ii) a half ester bond with an alkyl or alkenyl succinic anhydride, and
(iii) an ether bond with a carboxymethyl group, a carboxyethyl group, a hydroxyethyl group, a 2-hydroxypropyl group, or a cyanoethyl group.

7. The composite molded article (C) according to claim 1, wherein the cellulosic nanomaterial (A) has a minor axis of 1 nm to 10 μm.

8. The composite molded article (C) according to claim 1, wherein the thermoplastic resin (B) is at least one resin selected from the group consisting of polyolefins, polyamides, aliphatic polyesters, aromatic polyesters, polyacetals, polycarbonates, polystyrene, (meth)acrylic resins, acrylonitrile-butadiene-styrene copolymers (ABS resins), polycarbonate-ABS alloys (PC-ABS alloys), modified polyphenylene ethers (m-PPE), vinyl chloride resins, cellulosic resins, polylactic acid (PLA), polyhydroxybutyrate (PHBT), polyhydroxyhexanoate (PHAT), copolymers of polyhydroxybutyrate and polyhydroxyhexanoate (PHBH), and polybutylene succinate (PBS).

9. The composite molded article (C) according to claim 1, further comprising a compatibilizer and/or an inorganic filler.

10. The composite molded article (C) according to claim 1, wherein the content of the cellulosic nanomaterial (A) is 1 to 70 mass % based on the mass of the composite molded article (C).

11. A method for producing a composite molded article (C) comprising a cellulosic nanomaterial (A) and a thermoplastic resin (B), the method comprising:
(1) melting a composition comprising the cellulosic nanomaterial (A) and the thermoplastic resin (B) to prepare a molten composite composition comprising the cellulosic nanomaterial (A) and the thermoplastic resin (B) (step 1);
(2) molding the molten composite composition obtained in step 1 in a molten state, followed by cooling, thereby preparing a melt-molded article (D) (step 2); and
(3) warm-forming the melt-molded article (D) obtained in step 2 by at least one method selected from the group consisting of shearing, compression, stretching, and rolling (step 3),
an area under a stress-strain curve of the composite molded article (C) (AUC1) being at least two times an area under a stress-strain curve of the melt-molded article (D) (AUC2),
wherein the stress-strain curve is a curve drawn with strain (unit: %) on the horizontal axis and stress (unit: MPa) on the vertical axis and obtained by subjecting the composite molded article (C) or the melt-molded article (D) to a tensile test, and the area is an area up to the horizontal axis from under a curved portion of the curve that is from the origin (stress: 0) of the stress-strain curve to a fracture of the composite molded article (C) or the melt-molded article (D).

12. The method for producing a composite molded article (C) according to claim 11, wherein when the thermoplastic resin (B) is a crystalline resin, the temperature in the warm-forming is less than the melting point of the crystalline resin, when the thermoplastic resin (B) is an amorphous resin, the temperature in the warm-forming is less than the glass transition temperature of the amorphous resin, and when the thermoplastic resin (B) is a mixture of a crystalline resin and an amorphous resin, the temperature in the warm-forming is less than the melting point of the crystalline resin.

13. The method for producing a composite molded article (C) according to claim 11, wherein in the warm-forming, the ratio of the thickness of the composite molded article (C) (Ct) to the thickness of the melt-molded article (D) (Dt) (Ct/Dt) is 0.1 to 0.9.

14. A method for producing a composite molded article (C) comprising a cellulosic nanomaterial (A) and a thermoplastic resin (B), the method comprising:
(1) melting a composition comprising the cellulosic nanomaterial (A) and the thermoplastic resin (B) to prepare a molten composite composition comprising the cellulosic nanomaterial (A) and the thermoplastic resin (B) (step 1);
(2) injection-molding the molten composite composition obtained in step 1 to prepare an injection-molded article (E) (step 2); and
(3) warm-forming the injection-molded article (E) obtained in step 2 by at least one method selected from the group consisting of shearing, compression, stretching, and rolling (step 3),
an area under a stress-strain curve of the composite molded article (C) (AUC1) being at least two times an area under a stress-strain curve of the melt-molded article (D) (AUC2),
wherein the stress-strain curve is a curve drawn with strain (unit: %) on the horizontal axis and stress (unit: MPa) on the vertical axis and obtained by subjecting the composite molded article (C) or the melt-molded article (D) to a tensile test, and the area is an area up to the horizontal axis from under a curved portion of the curve that is from the origin (stress: 0) of the stress-strain curve to a fracture of the composite molded article (C) or the melt-molded article (D).

15. The composite molded article (C) according to claim 2, wherein the composite molded article (C) has a tensile elastic modulus (EMc) that is at least 1.05 times a tensile elastic modulus of the melt-molded article (D) having the same composition as that of the composite molded article (C) (EMd).

16. The composite molded article (C) according to claim 2, wherein the composite molded article (C) has at least one of the following features (1) to (4):
(1) the composite molded article (C) has a tensile elastic modulus (EMc) that is at least 1.05 times a tensile elastic modulus of the melt-molded article (D) having the same composition as that of the composite molded article (C) (EMd),
(2) the composite molded article (C) has a tensile strength that is at least 1.2 times a tensile strength of the melt-molded article (D) having the same composition as that of the composite molded article (C),
(3) the composite molded article (C) has a breaking strain that is at least two times a breaking strain of the melt-molded article (D) having the same composition as that of the composite molded article (C), and
(4) the composite molded article (C) has a coefficient of linear thermal expansion (CTE) at 40° C. to 80° C. of −5 to 147 (ppm/K).

17. The composite molded article (C) according to claim 2, wherein the cellulosic nanomaterial (A) is at least one cellulosic nanomaterial selected from the group consisting of microfibrillated cellulosic fibers, fine cellulosic powders, and cellulose nanocrystals, all of which are optionally chemically modified.

18. The composite molded article (C) according to claim 17, wherein the cellulosic nanomaterial (A) is at least one cellulosic nanomaterial in which some of the hydroxyl groups of sugar chains and/or lignin constituting the material are modified with at least one chemical bond selected from the group consisting of the following (i) to (iii), the at least one cellulosic nanomaterial being selected from the group consisting of microfibrillated cellulosic fibers, fine cellulosic powders, and cellulose nanocrystals:
(i) an ester bond with a carboxylic acid represented by the following formula (1):
R—COOH (1)
wherein R represents (a) an alkyl or alkenyl group, (b) an optionally crosslinked or fused alicyclic hydrocarbon group, (c) an oxyalkyl group substituted with an optionally crosslinked or fused alicyclic hydrocarbon group, or (d) a phenoxyalkyl group, an alkyl-substituted phenoxyalkyl group, or a phenoxyalkyl group substituted with an optionally crosslinked or fused alicyclic hydrocarbon group,
(ii) a half ester bond with an alkyl or alkenyl succinic anhydride, and
(iii) an ether bond with a carboxymethyl group, a carboxyethyl group, a hydroxyethyl group, a 2-hydroxypropyl group, or a cyanoethyl group.

19. The composite molded article (C) according to claim 2, wherein the cellulosic nanomaterial (A) has a minor axis of 1 nm to 10 μm.

20. The composite molded article (C) according to claim 2, wherein the thermoplastic resin (B) is at least one resin selected from the group consisting of polyolefins, polyamides, aliphatic polyesters, aromatic polyesters, polyacetals, polycarbonates, polystyrene, (meth)acrylic resins, acrylonitrile-butadiene-styrene copolymers (ABS resins), polycarbonate-ABS alloys (PC-ABS alloys), modified polyphenylene ethers (m-PPE), vinyl chloride resins, cellulosic resins, polylactic acid (PLA), polyhydroxybutyrate (PHBT), polyhydroxyhexanoate (PHAT), copolymers of polyhydroxybutyrate and polyhydroxyhexanoate (PHBH), and polybutylene succinate (PBS).

21. The composite molded article (C) according to claim 2, further comprising a compatibilizer and/or an inorganic filler.

22. The composite molded article (C) according to claim 2, wherein the content of the cellulosic nanomaterial (A) is 1 to 70 mass % based on the mass of the composite molded article (C).

23. The method for producing a composite molded article (C) according to claim 12, wherein in the warm-forming, the ratio of the thickness of the composite molded article (C) (Ct) to the thickness of the melt-molded article (D) (Dt) (Ct/Dt) is 0.1 to 0.9.
